(19) United States
(12) Patent Application Publication
(10) Pub. No.: US 2023/0129972 A1
(43) Pub. Date: Apr. 27, 2023

(54) CHARGING PROMPT METHOD, AND DEVICE AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventor: Yansong SHI, Dongguan (CN)

(21) Appl. No.: 18/146,627

(22) Filed: Dec. 27, 2022

Related U.S. Application Data
(63) Continuation of application No. PCT/CN2021/100862, filed on Jun. 18, 2021.

(30) Foreign Application Priority Data
Jul. 28, 2020 (CN) 202010736509.8

(51) Int. Cl. H02J 50/90; H02J 50/10; H02J 50/40

(52) U.S. Cl. CPC H02J 50/90; H02J 50/10; H02J 50/40

(57) ABSTRACT

Disclosed are a charging prompt method and related apparatus. The method includes: detecting whether there is a position offset between a second coil and a first coil according to a first Q value of the first coil; if there is a position offset between the second coil and the first coil, obtaining position-offset information between the second coil and the first coil; and outputting position-movement prompting information according to the position-offset information, and the position-movement prompting information being configured to prompt a user to move the second end device or the first end device based on the position-offset information.

### CROSS REFERENCE TO RELATED APPLICATIONS

The present application a continuation of International Patent Application No. PCT/CN2021/100862, filed Jun. 18, 2021, which claims priority to Chinese Patent Application No. 202010736509.8, filed Jul. 28, 2020, the entire disclosures of which are incorporated herein by reference.

### TECHNICAL FIELD

The present disclosure relates to the technical field of charging, in particular to a charging prompt method, a device, and a non-transitory computer-readable storage medium.

### BACKGROUND

Wireless charging is a technology that transmits electric energy by magnetic field and realizes charging without wire connection. Generally, in wireless charging technology, a device configured to provide the electric energy may be called a transmitting-end device, and a device configured to receive the electric energy to charge a battery therein may be called a receiving-end device. In practical applications, the transmitter device may include a transmitting coil. The transmitting coil may transmit an alternating magnetic field under a drive of an alternating current. Besides, the receiving-end device may include a receiving coil. The receiving coil may induce a current under a drive of the alternating magnetic field. The induced current may be configured to charge the battery of the receiving-end device.

At present, how to improve the charging power of the wireless charging has become an urgent problem.

### SUMMARY

In a first aspect, a charging prompt method for a first end device of a wireless charging system is provided. The wireless charging system includes the first end device and a second end device. The first end device is one of a receiving-end device and a transmitting-end device. The second end device is the other of the receiving-end device and the transmitting-end device. The first end device includes a first coil configured to transfer electric energy. The second end device includes a second coil configured to transfer the electric energy. The method includes the following operations: detecting whether a position offset exists between the second coil and the first coil according to a first Q value of the first coil; obtaining position-offset information between the second coil and the first coil in response to detecting that the position offset exists between the second coil and the first coil; and outputting position-movement prompting information according to the position-offset information. The position-movement prompting information is configured to prompt a user to move the second end device or the first end device based on the position-offset information.

In a second aspect, a first end device is provided. The first end device includes a first coil configured to transfer electric energy, a plurality of direction detecting coils, a detecting circuit, and an outputting circuit. The plurality of direction detecting coils are arranged around the first coil. The first coil and the plurality of direction detecting coils are connected to the detecting circuit. The detecting circuit is connected to the outputting circuit. The detecting circuit is configured to detect a first Q value of the first coil and a second Q value of each of the plurality of direction detecting coils. The detecting circuit is further configured to determine whether a position offset exists between the first coil and a second coil of a second end device according to the first Q value, and the second coil is configured to transfer electric energy. The detecting circuit is further configured to obtain a target offset distance between the second coil and the first coil according to the first Q value and determine a target offset direction of the second coil relative to the first coil according to the second Q value of each of the plurality of direction detecting coils in response to detecting that the position offset exists between the second coil and the first coil. The outputting circuit is configured to output position-movement prompting information under a control of the detecting circuit. The position-movement prompting information is configured to prompt a user to move the second end device or the first end device based on the target offset distance and the target offset direction.

In a third aspect, a non-transitory computer-readable storage medium is provided, on which a computer program is stored. In response to the computer program being executed by a processor, the charging prompt method as described in the aforesaid first aspect is executed.

### BRIEF DESCRIPTION OF THE DRAWINGS

FIG. 1 is a schematic diagram of an implementation environment provided by some embodiments of the present disclosure.

FIG. 2 is a flow chart of a charging prompt method provided by some embodiments of the present disclosure.

FIG. 3 is a schematic diagram of a central axis of a coil provided by some embodiments of the present disclosure.

FIG. 4 is a schematic diagram of an arranging mode of a plurality of direction detecting coils and a first coil provided by some embodiments of the present disclosure.

FIG. 5 is a flow chart of a technical process of a first end device detecting whether there is a position offset between a second coil and the first coil provided by some embodiments of the present disclosure.

FIG. 6 is a flow chart of a technical process of the first end device detecting a target offset direction of the second coil relative to the first coil provided by some embodiments of the present disclosure.

FIG. 7 is the block diagram of a charging prompt apparatus provided by some embodiments of the present disclosure.

FIG. 8 is a block diagram of the first end device provided by some embodiments of the present disclosure.

FIG. 9 is a block diagram of the first end device provided by some embodiments of the present disclosure.

FIG. 10 is a schematic diagram of a voltage resonant waveform provided by some embodiments of the present disclosure.

FIG. 11 is a block diagram of the first end device provided by some embodiments of the present disclosure.

FIG. 12 is a block diagram of the first end device provided in some embodiments of the present disclosure.

FIG. 13 is a schematic diagram of a Q value measurement circuit provided by some embodiments of the present disclosure.

FIG. 14 is a block diagram of a wireless charging system provided by some embodiments of the present disclosure.

### DETAILED DESCRIPTIONS

In order to make the purpose, technical solution and advantages of the present disclosure clearer, the embodiments of the present disclosure will be further described in detail below in combination with the accompanying figures.

In a field of wireless charging technology, a transmitter device may include a transmitting coil, and a receiving-end device may include a receiving coil. The transmitting coil may transmit an alternating magnetic field under a drive of an alternating current. The receiving coil may induce a current under a drive of the alternating magnetic field. The receiving-end device may use the induced current to charge a battery.

In practical applications, a charging power of wireless charging may be maximized only in case that the transmitting coil and the receiving coil are aligned with each other. In case that the transmitting coil and the receiving coil are not aligned with each other, that is, there is a position offset between the transmitting coil and the receiving coil, the charging power of the wireless charging cannot be maximized.

Considering the aforesaid situation, some embodiments of the present disclosure provide a charging prompt method. In the charging prompt method, a first end device is configured to detect whether there is a position offset between a second coil and a first coil, obtain a target offset distance between the second coil and the first coil and detect a target offset direction of the second coil relative to the first coil by using a plurality of direction detecting coils of the first end device in case that there is the position offset between the second coil and the first coil, and output position-movement prompting information according to the target offset direction and the target offset distance. The position-movement prompting information is configured to prompt a user to move the second end device or the first end device based on the target offset distance and the target offset direction. The first end device may be one of the transmitting-end device and the receiving-end device, and the second end device may be the other of the transmitting-end device and the receiving-end device. The first end device includes a first coil configured to transfer electric energy, and the second end device includes a second coil configured to transfer the electric energy. In this case, in a process of the wireless charging, the method may be configured to detect whether there is the position offset between the second coil and the first coil, and remind the user in case that the position offset is detected. The user may change a position of the second end device or the first end device according to the offset direction and the offset distance in the prompt information, so that the second coil and the first coil are aligned with each other. The charging power of the wireless charging may be maximized only in case that the second coil and the first coil are aligned with each other, therefore, the technical solution provided by some embodiments of the present disclosure may maximize the charging power by outputting the position-movement prompting information based on the target offset direction and target offset distance, and the charging power of the wireless charging may be improved.

An implementation environment involved in the charging prompt method provided by some embodiments of the present disclosure will be briefly described below.

As shown in FIG. 1, the implementation environment may include a first end device 101 and a second end device 102. Electric energy may be transferred between the first end device 101 and the second end device 102 through an alternating magnetic field. The first end device 101 may be one of the transmitting-end device and the receiving-end device, and the second end device 102 may be the other of the transmitting-end device and the receiving-end device. For example, the first end device 101 may be the transmitting-end device, and the second end device 102 may be the receiving-end device. In some embodiments, the first end device 101 may be the receiving-end device, and the second end device 102 may be the transmitting-end device.

The first end device 101 may include a first coil configured to transfer the electric energy. For example, in case that the first end device 101 is the transmitting-end device, the first coil may be the transmitting coil; and in case that the first end device 101 is the receiving-end device, the first coil may be the receiving coil. The second end device 102 may include a second coil configured to transfer the electric energy. For example, in case that the second end device 102 is the transmitting-end device, the second coil may be the transmitting coil; and in case that the second end device 102 is the receiving-end device, the second coil may be a receiving coil.

In some embodiments of the present disclosure, in the first end device 101, a plurality of direction detecting coils may also be arranged around the first coil. A description of the plurality of direction detecting coils may refer to the following description of some embodiments of the present disclosure.

It should be noted that, in some embodiments of the present disclosure, the transmitting-end device may be a wireless charging base or other devices that may provide the electric power. The receiving-end device may be a mobile phone, a tablet computer, a wearable device, an e-book reader, or other devices that need to charge a battery.

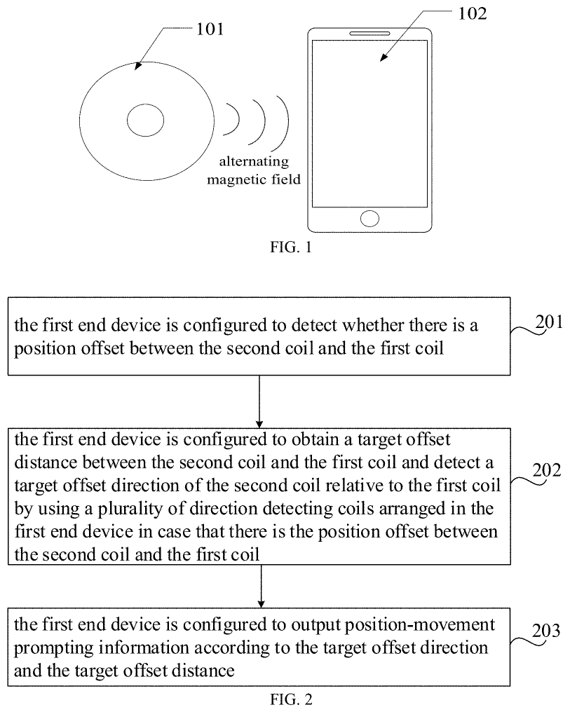

As shown in FIG. 2, FIG. 2 is a flow chart of a charging prompt method provided by some embodiments of the present disclosure. The charging prompt method may be applied to the first end device of the implementation environment shown in FIG. 1. As shown in FIG. 2, the charging prompt method may include the following operations.

Operation 201, the first end device is configured to detect whether there is a position offset between the second coil and the first coil.

It should be noted that “there is a position offset between the second coil and the first coil” and “the second coil and the first coil are aligned with each other” are two opposite concepts.

In some embodiments, “the second coil and the first coil are aligned with each other” means that central axes of the second coil and the first coil coincide with each other, and relatively, “there is a position offset between the second coil and the first coil” means that central axes of the second coil and the first coil do not coincide with each other.

In some embodiments, “the second coil and the first coil are aligned with each other” means that a distance between the central axes of the second coil and the first coil is less than or equal to a preset axis distance threshold, and relatively, “there is a position offset between the second coil and the first coil” means that the distance between the central axes of the second coil and the first coil is greater than the preset axis distance threshold.

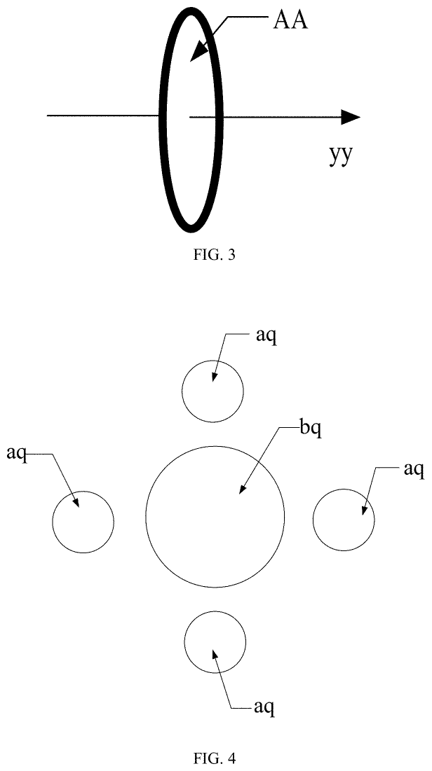

It should be noted that, a coil usually refers to wire windings in a ring shape, and the central axis of the coil refers to a symmetrical axis of the wire windings. The central axis of the coil is perpendicular to a plane on which a ring of the wire windings is located. As shown in FIG. 3, FIG. 3 shows the central axis yy of the coil AA. As shown in FIG. 3, the central axis yy is the symmetrical axis of the coil AA, and the central axis yy is perpendicular to a plane on which the ring of the coil AA is located.

In some embodiments, the first end device may be configured to execute a technical process of detecting whether there is a position offset between the second coil and the first coil in response to determining that there is a second end device around the first end device. For example, the first end device may periodically transmit an energy pulse by using the first coil, and the second end device may reply another energy pulse to the first end device after receiving the energy pulse. In case that the first end device receives another energy pulse, the first end device may determine that there is a second end device around the first end device. In this case, the first end device may be configured to execute the technical process of detecting whether there is a position offset between the second coil and the first coil. In some embodiments, the second end device may periodically transmit an energy pulse by using the second coil. In case that the first end device receives the energy pulse, the first end device may determine that there is a second end device around the first end device. In this case, the first end device may execute the technical process of detecting whether there is a position offset between the second coil and the first coil.

In some embodiments, the first end device may be configured to periodically execute the technical process of detecting whether there is a position offset between the second coil and the first coil. In case that there is a second end device around the first end device, the first end device may be configured to determine whether there is a position offset between the second coil and the first coil through detection. In case that there is no second end device around the first end device, the first end device may be configured to determine that there is no second end device around the first end device by detection.

Operation 202, the first end device is configured to obtain a target offset distance between the second coil and the first coil and detect a target offset direction of the second coil relative to the first coil by using a plurality of direction detecting coils arranged in the first end device in case that there is the position offset between the second coil and the first coil.

It should be noted that, the target offset distance between the second coil and the first coil may refer to a distance between the central axes of the second coil and the first coil. The target offset direction of the second coil relative to the first coil may refer to a direction of a position of the second coil relative to a position of the first coil. For example, the target offset direction may be lower, upper, left, right, upper left, lower left, upper right, lower right, and the like.

In some embodiments of the present disclosure, the first end device may include a plurality of direction detecting coils, and the first end device may detect the target offset direction of the second coil relative to the first coil by using the plurality of direction detecting coils.

The plurality of direction detecting coils are arranged around the first coil. The direction detecting coil is different from the first coil in that the direction detecting coil is not configured to transfer the electric energy to the second end device. In some embodiments, sizes of the plurality of direction detecting coils may be the same as each other. In some embodiments, the size of each of the plurality of direction detecting coils may be less than a size of the first coil.

In some embodiments of the present disclosure, the plurality of direction detecting coils have different arranging orientations relative to the first coil. In some embodiments, a geometric center of arranging positions of the plurality of direction detecting coils may be the first coil. In some embodiments, as shown in FIG. 4, the first end device may include four direction detecting coils aq. One direction detecting coil aq is arranged above the first coil bq. One direction detecting coil aq is arranged below the first coil bq. One direction detecting coil aq is arranged on the left of the first coil bq. One direction detecting coil aq is arranged on the right of the first coil bq.

In some embodiments of the present disclosure, the distances between the first coil and the plurality of direction detecting coils are the same as each other. A distance between coils refers to a distance between the central axes of the coils. Of course, in some embodiments of the present disclosure, the distances between the first coil and the plurality of direction detecting coils may also be different from each other.

In practical applications, it is difficult to achieve that the second coil and the first coil are completely aligned with each other, i.e., there is no position offset between the second coil and the first coil. In addition, generally, it is not necessary to force the user to ensure that the second coil and the first coil are completely aligned with each other. Considering this situation, in order to save process and simplify operations of the user, in the operation 202, the first end device may be configured to obtain the target offset distance between the second coil and the first coil in case that there is the position offset between the second coil and the first coil. After obtaining the target offset distance, the first end device may be configured to detect whether the target offset distance is greater than a preset distance threshold. In case that the target offset distance is greater than the preset distance threshold, the first end device is configured to execute a technical process of detecting the target offset direction of the second coil relative to the first coil. Otherwise, in case that the target offset distance is not greater than the preset distance threshold, the first end device does not need to execute the technical process of detecting the target offset direction of the second coil relative to the first coil, and then, the first end device does not need to execute the subsequent technical processes in some embodiments of the present disclosure.

Operation 203, the first end device is configured to output position-movement prompting information according to the target offset direction and the target offset distance.

The position-movement prompting information is configured to prompt the user to move the second end device or the first end device based on the target offset distance and the target offset direction.

For example, in case that the target offset distance is 1 cm and the target offset direction is lower left, the position-movement prompting information may prompt the user to move the second end device by 1 cm to the upper right. In this way, after the second end device is moved, the first coil and the second coil may be aligned with each other.

In some embodiments, in case that the first end device is the transmitting-end device and the second end device is the receiving-end device, the first end device may output the position-movement prompting information to the second end, and the position-movement prompting information is displayed by the second end device. In case that the first end device is the receiving-end device and the second end device is the transmitting-end device, the first end device may output the position-movement prompting information to a display component (for example, the display screen, etc.) of the first end device, and the position-movement prompting information is displayed by the display component of the first end device.

In some embodiments of the present disclosure, the position-movement prompting information may be displayed in a form of a diagram. For example, the diagram may be an arrow, a direction pointed by the arrow is the target offset direction or an opposite direction of the target offset direction, and a length of the arrow is the target offset distance. In this way, the user may intuitively understand how to move the second end device or the first end device.

The charging prompt method provided by some embodiments of the present disclosure is configured to detect whether there is the position offset between the second coil and the first coil by using the first end device, obtain the target offset distance between the second coil and the first coil and detect the target offset direction of the second coil relative to the first coil by using a plurality of direction detecting coils of the first end device in case that there is the position offset between the second coil and the first coil, and output the position-movement prompting information according to the target offset direction and target offset distance. The position-movement prompting information is configured to prompt the user to move the second end device or the first end device based on the target offset distance and the target offset direction. The first end device may be one of the transmitting-end device and the receiving-end device, and the second end device may be the other of the transmitting-end device and the receiving-end device. The first end device includes a first coil configured to transfer the electric energy, and the second end device includes a second coil configured to transfer the electric energy. In this way, in a process of the wireless charging, the method may be configured to detect whether there is the position offset between the second coil and the first coil, and remind the user in case that the position offset is detected. The user may change a position of the second end device or the first end device according to the offset direction and the offset distance in the prompt information, so that the second coil and the first coil are aligned with each other. The charging power of the wireless charging may be maximized only in case that the second coil and the first coil are aligned with each other. Therefore, the technical solution provided by some embodiments of the present disclosure may maximize the charging power by outputting the position-movement prompting information based on the target offset direction and the target offset distance, and the charging power of the wireless charging may be improved.

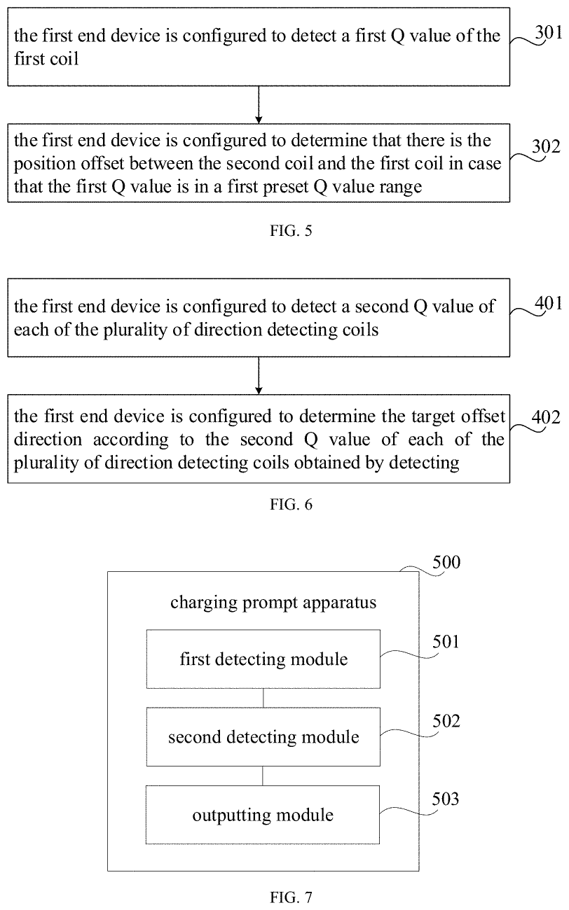

As shown in FIG. 5, in some embodiments of the present disclosure, the technical process of the first end device detecting whether there is a position offset between the second coil and the first coil may include the following operations.

Operation 301, the first end device is configured to detect a first Q value of the first coil.

A Q value may also be referred to as a quality factor, which refers to a ratio of an inductive reactance presented by an inductance (a coil is an inductance) when the inductance is excited to generate a resonance to an equivalent loss resistance thereof.

Generally, the inductance may be excited by an alternating current to generate the resonance only in case that the inductance is connected to a capacitor (in parallel or in series) to form a resonant circuit. Therefore, the Q value of the inductance is generally calculated based on the resonant circuit in which the inductance is located. In practical applications, the Q value of the inductance may be calculated by using the following formula: Q=wL/R=1/wRC.

Herein, Q refers to the Q value, w refers to a frequency of the alternating current configured for excitation, L refers to an inductance value of the inductance, R refers to a resistance value of the resistance in series in the resonant circuit, and C refers to a capacitance value of the capacitor in the resonant circuit.

It can be seen from the aforesaid formula that, the first Q value of the first coil is related to the inductance value of the first coil. In practical applications, in case that there is a coil around the first coil (such as the second coil), the first coil will be coupled with the coil that exists around the first coil to generate mutual inductance, thereby causing the inductance value of the first coil to change. In addition, a magnitude of a change of the inductance value of the first coil is also related to a degree of the position offset between the first coil and the coil that exists around. Generally, the greater the degree of the position offset, the smaller the change of the inductance value of the first coil, and the smaller the degree of the position offset, the greater the change of the inductance value of the first coil. Since the first Q value of the first coil is related to the inductance value of the first coil, the change of the inductance value of the first coil will inevitably lead to the changes of the first Q value of the first coil, and a degree of the change of the first Q value of the first coil is related to the degree of the change of the inductance value of the first coil.

Based on the aforesaid principle, in some embodiments of the present disclosure, the first end device may be configured to detect whether there is the position offset between the second coil and the first coil based on the first Q value of the first coil. For this purpose, the first end device may be configured to excite the first coil to generate a resonance, and detect the first Q value of the first coil after the first coil generates the resonance.

Operation 302, the first end device is configured to determine that there is the position offset between the second coil and the first coil in case that the first Q value is in a first preset Q value range.

The first preset Q value range is a range of the Q value of the first coil in case that a coil exists in a preset range around the first coil and there is a position offset between the coil that exists around and the first coil.

In some embodiments, in case that the first Q value is in a third preset Q value range, the first end device is configured to determine that there is no position offset between the second coil and the first coil. The third preset Q value range is a range of the Q value of the first coil in case that a coil exists in the preset range around the first coil and there is no position offset between the coil that exists around and the first coil.

In some embodiments, in case that the first Q value is in a fourth preset Q value range, the first end device is configured to determine that no second coil exists in a preset range around the first end device. The fourth preset Q value range is the range of the Q value of the first coil in case that no coil exists in a preset range around the first coil.

Generally, the third preset Q value range is larger than the first preset Q value range, and the first preset Q value range is larger than the fourth preset Q value range.

Corresponding to the technical process of detecting whether there is a position offset between the second coil and the first coil described aforesaid, a technical process of the first end device obtaining the target offset distance between the second coil and the first coil may include the following operations: the first end device is configured to obtain the target offset distance according to the first Q value.

For example, the first end device may be configured to query a distance database according to the first Q value, and obtain the target offset distance through the query. The distance database stores at least one corresponding relationship between the Q value and the offset distance.

In some embodiments, the corresponding relationship stored in the distance database may be as shown in Table 1.

TABLE 1

| Q value | Offset distance |
|---|---|
| a | X1 |
| b | X2 |
| c | X3 |
| . . . | . . . |

As shown in Table 1, in case that the first Q value is a, the target offset distance X1 may be obtained by querying the distance database.

Of course, in some embodiments of the present disclosure, the distance database may also store at least one corresponding relationship between the Q value range and the offset distance.

In some embodiments, the corresponding relationship stored in the distance database may be as shown in Table 2.

TABLE 2

| Q value range | Offset distance |
|---|---|
| [a, b] | X1 |
| [c, d] | X2 |
| [e, f] | X3 |
| . . . | . . . |

As shown in Table 2, if the first Q value is in a range of [a, b], the target offset distance X1 may be obtained by querying the distance database.

In some embodiments, an offset distance calculation function may be arranged in the first end device, and the first end device may substitute the first Q value into the offset distance calculation function to calculate the target offset distance. The embodiments of the present disclosure do not define the specific technical process of calculating the target offset distance.

As shown in FIG. 6, in some embodiments of the present disclosure, the technical process of the first end device detecting the target offset direction of the second coil relative to the first coil may include the following operations.

Operation 401, the first end device is configured to detect a second Q value of each of the plurality of direction detecting coils.

In some embodiments of the present disclosure, the first end device may excite each of the plurality of direction detecting coils to generate a resonance. For each direction detecting coil, after the direction detecting coil generates the resonance, the first end device may be configured to detect the second Q value of the direction detecting coil.

Operation 402, the first end device is configured to determine the target offset direction according to the second Q value of each of the plurality of direction detecting coils obtained by detecting.

In some embodiments of the present disclosure, the first end device may be configured to screen one or more target Q values from the second Q value of each of the plurality of direction detecting coils. Each of the one or more target Q values is in a second preset Q value range. The second preset Q value range is a range of the Q value of each of the plurality of direction detecting coils in case that a coil exists in a preset range around the each of the plurality of direction detecting coils.

It can be seen from the aforesaid description that the second coil exists in the preset range around the direction detecting coil corresponding to the target Q value. In some embodiments of the present disclosure, the first end device may be configured to determine the target offset direction according to one or more arranging orientations of one or more of the plurality of direction detecting coils corresponding to the one or more target Q values relative to the first coil.

In some embodiments, in case that the number of the one or more target Q values is 1, the number of the one or more of the plurality of direction detecting coils corresponding to the one or more target Q values is also 1. That is, the number of the one or more of the plurality of direction detecting coils having the second coil existing around is 1. In this case, the first end device may be configured to take a first arranging orientation of one of the plurality of direction detecting coils corresponding to the one target Q value relative to the first coil as the target offset direction.

In some embodiments, in case that the number of the one or more target Q values is greater than 1, the number of one or more of the plurality of direction detecting coils corresponding to the one or more target Q values is also greater than 1 (that is, at least two). That is, there are at least two of the plurality of direction detecting coils having the second coil existing around. In this case, the first end device may be configured to determine second arranging orientations of the at least two of the plurality of direction detecting coils corresponding to the one or more target Q values relative to the first coil, and determine the target offset direction according to the second arranging orientations of the at least two of the plurality of direction detecting coils.

In some embodiments, the first end device may be configured to take an orientation between the second arranging orientations of the at least two of the plurality of direction detecting coils as the target offset direction. For example, in case that the second arranging orientations of the at least two of the plurality of direction detecting coils is left and upper respectively, the first end device may be configured to take upper left as the target offset direction.

In some embodiments, the first end device may be configured to determine a target second arranging orientation from the second arranging orientations of the at least two of the plurality of direction detecting coils based on the one or more target Q values, and take the target second arranging orientation as the target offset direction.

For example, the first end device may be configured to determine a maximum target Q value from the one or more target Q values, and take the second arranging orientation of one of the plurality of direction detecting coils corresponding to the maximum target Q value (that is, the target second arranging orientation) as the target offset direction relative to the first coil.

In some embodiments, the first end device may be configured to calculate the target offset direction based on a preset direction calculation formula by using the second arranging orientations and the one or more target Q values corresponding to the second arranging orientations.

For example, independent variables of the direction calculation formula may be an orientation expression value corresponding to each second arranging orientation and the target Q value corresponding to each second arranging orientation, and dependent variables of the direction calculation formula may be an orientation expression value corresponding to the target offset direction. In this way, the orientation expression value corresponding to the target offset direction may be calculated according to the direction calculation formula, and the first end device may be configured to determine the target offset direction according to the orientation expression value corresponding to the target offset direction.

It should be noted that, in the charging prompt method provided by some embodiments of the present disclosure, the first end device may be configured to detect whether there is the position offset between the first coil and the second coil based on the first Q value. Besides, the first end device may also be configured to obtain the target offset distance between the first coil and the second coil based on the first Q value. In addition, the first end device may also be configured to detect the target offset direction of the second coil relative to the first coil based on the second Q value of each of the plurality of direction detecting coils. The first Q value and each second Q value may be detected before the first coil transmits the alternating magnetic field, that is, the first Q value and each second Q value may be detected before the wireless charging. In this way, the first end device may prompt the user to move the second end device before a start of the wireless charging, so that a maximum charging power may be achieved at a beginning of the wireless charging.

In some embodiments, a charging prompt method for a first end device of a wireless charging system is provided. The wireless charging system includes the first end device and a second end device. The first end device is one of a receiving-end device and a transmitting-end device. The second end device is the other of the receiving-end device and the transmitting-end device. The first end device includes a first coil configured to transfer electric energy. The second end device includes a second coil configured to transfer the electric energy. The method includes the following operations: detecting whether a position offset exists between the second coil and the first coil according to a first Q value of the first coil; obtaining position-offset information between the second coil and the first coil in response to detecting that the position offset exists between the second coil and the first coil; and outputting position-movement prompting information according to the position-offset information. The position-movement prompting information is configured to prompt a user to move the second end device or the first end device based on the position-offset information.

In some embodiments, the first end device further includes a plurality of direction detecting coils around the first coil. The position-offset information includes a target offset distance and a target offset direction. The obtaining position-offset information between the second coil and the first coil includes: obtaining a target offset distance between the second coil and the first coil and detecting a target offset direction of the second coil relative to the first coil by using the plurality of direction detecting coils.

In some embodiments, the method is executed before transferring the electric energy.

As shown in FIG. 7, FIG. 7 is the block diagram of a charging prompt apparatus 500 provided by some embodiments of the present disclosure. The charging prompt apparatus 500 may be configured in the first end device of the implementation environment shown in FIG. 1. As shown in FIG. 7, the charging prompt apparatus 500 may include a first detecting module 501, a second detecting module 502, and an outputting module 503.

The first detecting module 501 is configured to detect whether there is a position offset between the second coil and the first coil.

The second detecting module 502 is configured to obtain a target offset distance between the second coil and the first coil and detect a target offset direction of the second coil relative to the first coil by using a plurality of direction detecting coils in case that there is the position offset between the second coil and the first coil.

The outputting module 503 is configured to output position-movement prompting information according to the target offset direction and the target offset distance, and the position-movement prompting information is configured to prompt a user to move the second end device or the first end device based on the target offset distance and the target offset direction.

In some embodiments of the present disclosure, the first detecting module 501 is specifically configured to detect a first Q value of the first coil, and determine that there is the position offset between the second coil and the first coil in case that the first Q value is in a first preset Q value range. The first preset Q value range is a range of a Q value of the first coil in case that a coil exists in a preset range around the first coil and there is a position offset between the coil that exists around and the first coil.

In some embodiments of the present disclosure, the second detecting module 502 is specifically configured to obtain the target offset distance according to the first Q value.

In some embodiments of the present disclosure, the second detecting module 502 is specifically configured to detect a second Q value of each of the plurality of direction detecting coils; and determine the target offset direction according to the second Q value of each of the plurality of direction detecting coils obtained by detecting.

In some embodiments of the present disclosure, the second detecting module 502 is specifically configured to screen one or more target Q values from the second Q value of each of the plurality of direction detecting coils, and determine the target offset direction according to one or more arranging orientations of one or more of the plurality of direction detecting coils corresponding to the one or more target Q values relative to the first coil. Herein, each of the one or more target Q values is in a second preset Q value range, and the second preset Q value range is a range of a Q value of each of the plurality of direction detecting coils in case that a coil in a preset range around the each of the plurality of direction detecting coils.

In some embodiments of the present disclosure, the second detecting module 502 is specifically configured to determine a first arranging orientation of one of the plurality of direction detecting coils corresponding to the one or more target Q values relative to the first coil in case that the number of the one or more target Q values is 1, and take the first arranging orientation as the target offset direction; and determine second arranging orientations of at least two of the plurality of direction detecting coils corresponding to the one or more target Q values relative to the first coil in case that the number of the one or more target Q values is greater than 1, and determine the target offset direction according to the second arranging orientations of the at least two of the plurality of direction detecting coils.

In some embodiments of the present disclosure, the second detecting module 502 is specifically configured to take an orientation between the second arranging orientations of the at least two of the plurality of direction detecting coils as the target offset direction; or determine a target second arranging orientation from the second arranging orientations of the at least two of the plurality of direction detecting coils according to each of the one or more target Q values, and take the target second arranging orientation as the target offset direction; or calculate the target offset direction based on a preset direction calculation formula by using the second arranging orientations and the one or more target Q values corresponding to the second arranging orientations.

In some embodiments of the present disclosure, the second detecting module 502 is specifically configured to detect the target offset direction in case that the target offset distance is greater than a preset distance threshold.

The charging prompt apparatus provided by some embodiments of the present disclosure may execute the aforesaid method embodiments. The implementation principle and technical effect are similar, which are not repeated herein.

The specific definition of the charging prompt apparatus may refer to the definition of the charging prompt method described aforesaid, which is not repeated herein. Each of the modules in the charging prompt apparatus may be realized in whole or in part by a software, a hardware, and a combination thereof. Each of the aforesaid modules may be embedded in or independent of a processor of an electronic device in a form of hardware, or may be stored in a memory of the electronic device in a form of software, so that the processor may call and execute corresponding operations of corresponding to each of the aforesaid modules.

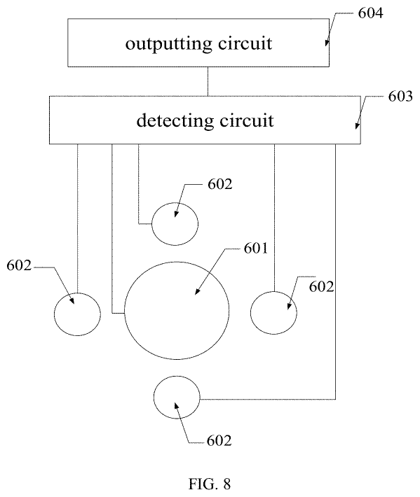

As shown in FIG. 8, FIG. 8 is a block diagram of the first end device provided by some embodiments of the present disclosure. As shown in FIG. 8, the first end device includes a first coil 601 configured to transfer electric energy, a plurality of direction detecting coils 602 (only four direction detecting coils 602 are shown in FIG. 8 by example), a detecting circuit 603, and an outputting circuit 604.

As described aforesaid, the direction detecting coil 602 is different from the first coil 601 in that the direction detecting coil 602 is not configured to transmit the electric energy to the second end device.

In some embodiments, the plurality of direction detecting coils 602 are arranged around the first coil 601, and arranging orientations of the plurality of direction detecting coils 602 relative to the first coil 601 are different from each other. In other words, the plurality of direction detecting coils 602 are uniformly arranged around the first coil 601 with the first coil 601 as a geometric center. As shown in FIG. 8, the first end device may include four direction detecting coils 602, one direction detecting coil 602 is arranged above the first coil 601, one direction detecting coil 602 is arranged below the first coil 601, one direction detecting coil 602 is arranged on the left of the first coil 601, and one direction detecting coil 602 is arranged on the right of the first coil 601.

In some embodiments, the sizes of the plurality of direction detecting coils 602 may be the same as each other. In some embodiments, a size of each of the plurality of direction detecting coils 602 may be smaller than a size of the first coil 601. In some embodiments of the present disclosure, the distances between the first coil 601 and the plurality of direction detecting coils 602 and are the same as each other, and a distance between coils may refer to a distance between central axes of the coils. Of course, in some embodiments of the present disclosure, the distances between the first coil 601 and the plurality of direction detecting coils 602 may also be different from each other.

As shown in FIG. 8, the first coil 601 and the plurality of direction detecting coils 602 are connected to the detecting circuit 603. The detecting circuit 603 is connected to the outputting circuit 604.

The detecting circuit 603 is configured to detect a first Q value of the first coil 601 and a second Q value of each of the plurality of direction detecting coils 602. The detecting circuit 603 is also configured to detect whether there is a position offset between the second coil and the first coil 601 according to the first Q value. In case that there is the position offset between the second coil and the first coil 601, the detecting circuit 603 is further configured to obtain a target offset distance between the second coil and the first coil 601 according to the first Q value, and detect a target offset direction of the second coil relative to the first coil 601 according to the second Q value of each of the plurality of direction detecting coils 602.

The outputting circuit 604 is configured to output position-movement prompting information under a control of the detecting circuit 603. The position-movement prompting information is configured to prompt a user to move the second end device or the first end device based on the target offset distance and the target offset direction.

It should be noted that, the detection circuit 603 detects whether there is a position offset between the second coil and the first coil 601, obtains a target offset distance between the second coil and the first coil 601, and detects a target offset direction of the second coil relative to the first coil 601 in manners similar to the aforesaid embodiments, and the following is a relatively brief description thereof in some embodiments of the present disclosure. Please refer to the content of the method embodiments of the present disclosure for details.

In some embodiments of the present disclosure, the detecting circuit 603 is specifically configured to determine that there is the position offset between the second coil and the first coil 601 in case that the first Q value is in a first preset Q value range. The first preset Q value range is a range of a Q value of the first coil in case that a coil exists in a preset range around the first coil and there is a position offset between the coil that exists around and the first coil.

In some embodiments of the present disclosure, the detecting circuit 603 is specifically configured to obtain the target offset distance according to the first Q value.

In some embodiments of the present disclosure, the detecting circuit 603 is specifically configured to screen one or more target Q values from the second Q value of each of the plurality of detected direction detecting coils 602, and determine the target offset direction according to one or more arranging orientations of one or more of the plurality of direction detecting coils 602 corresponding to the one or more target Q values relative to the first coil 601. Herein, each of the one or more target Q values is in a second preset Q value range, and the second preset Q value range is a range of a Q value of each of the plurality of direction detecting coils 602 in case that a coil exists in a preset range around the each of the plurality of direction detecting coils 602.

In some embodiments of the present disclosure, the detecting circuit 603 is specifically configured to determine a first arranging orientation of one of the plurality of direction detecting coils 602 corresponding to the one or more target Q values relative to the first coil 601 in case that the number of the one or more target Q values is 1, and take the first arranging orientation as the target offset direction; and determine second arranging orientations of at least two of the plurality of direction detecting coils 602 corresponding to the one or more target Q values relative to the first coil 601 in case that the number of the one or more target Q values is greater than 1, and determine the target offset direction according to the second arranging orientations of the at least two of the plurality of direction detecting coils 602.

In some embodiments of the present disclosure, the detecting circuit 603 is specifically configured to take an orientation between the second arranging orientations of the at least two of the plurality of direction detecting coils as the target offset direction; or determine a target second arranging orientation from the second arranging orientations of the at least two of the plurality of direction detecting coils according to each of the one or more target Q values, and take the target second arranging orientation as the target offset direction; or calculate the target offset direction based on a preset direction calculation formula by using the second arranging orientations and the one or more target Q values corresponding to the second arranging orientations.

In some embodiments of the present disclosure, the detecting circuit 603 is specifically configured to detect the target offset direction according to the second Q value of each of the plurality of direction detecting coils in case that the target offset distance is greater than a preset distance threshold.

As shown in FIG. 9, in some embodiments of the present disclosure, the detecting circuit 603 may include one or more Q value measurement circuits 6031 and a processing circuit 6032 connected to each other. The one or more Q value measurement circuits 6031 are connected to the first coil 601 and the plurality of direction detecting coils 602. The processing circuit 6032 is connected to the outputting circuit 604.

The one or more Q value measurement circuits 6031 are configured to excite the first coil 601 and each of the plurality of direction detecting coils 602 to generate resonances, sample voltages at two ends of the first coil 601 and voltages at two ends of each of the plurality of direction detecting coils 602 after the first coil 601 and each of the plurality of direction detecting coils 602 generate the resonances, and output sampling results to the processing circuit 6032.

The processing circuit 6032 is configured to acquire the first Q value and the second Q value of each of the plurality of direction detecting coils 602 according to the sampling results. The processing circuit 6032 is further configured to detect whether there is the position offset between the second coil and the first coil 601 according to the first Q value. In case that there is the position offset between the second coil and the first coil 601, the processing circuit 6032 is further configured to obtain the target offset distance according to the first Q value, and detect the target offset direction according to the second Q value of each of the plurality of direction detecting coils 602. The processing circuit 6032 is further configured to control the outputting circuit 604 to output the position-movement prompting information.

In some embodiments of the present disclosure, the processing circuit 6032 may also be connected to the first coil 601. The processing circuit 6032 is further configured to control the first coil 601 to transmit an alternating magnetic field under a drive of an alternating current.

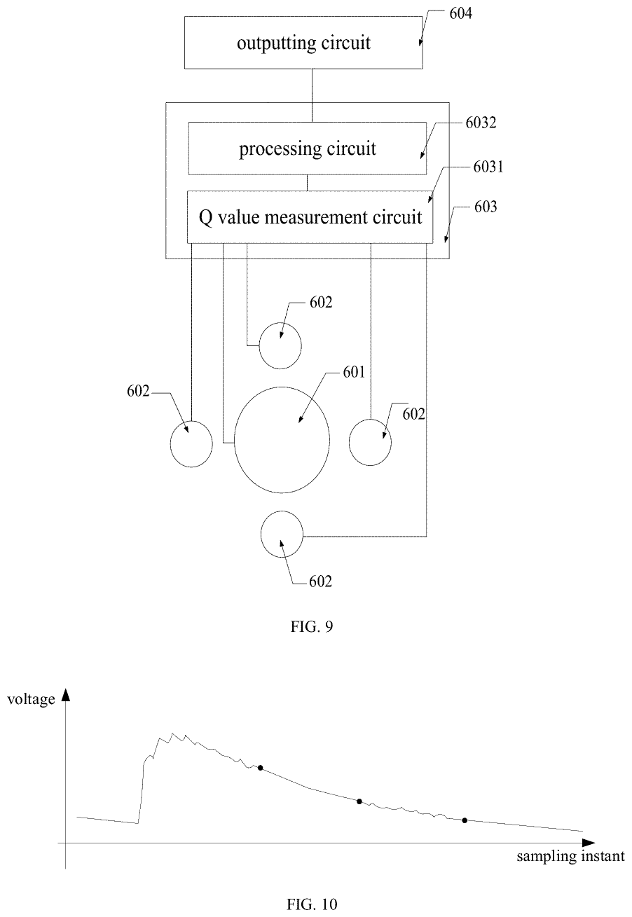

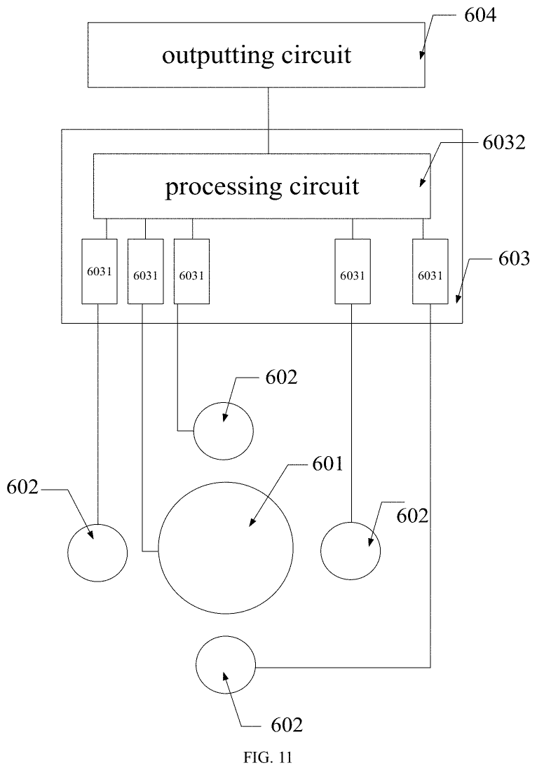

In some embodiments of the present disclosure, the sampling results outputted by the one or more Q value measurement circuits 6031 to the processing circuit 6032 may be voltage resonant waveforms corresponding to the first coil 601 and each of the plurality of direction detecting coils 602. An x-axis coordinate of any point in each voltage resonant waveform is a sampling instant of the corresponding point, and a y-axis coordinate is a voltage of the corresponding point. As shown in FIG. 10, FIG. 10 shows an exemplary voltage resonant waveform.

After receiving a voltage resonant waveform corresponding to the first coil 601, the processing circuit 6032 may be configured to determine at least one point from the voltage resonant waveform, and acquire the first Q value based on the voltage and the sampling instant corresponding to the at least one point. For example, as shown in FIG. 10, the processing circuit 6032 may be configured to determine three points from the voltage resonant waveform, and time intervals between the sampling instants corresponding to any two adjacent points of the three points are the same as each other.

Similarly, after receiving a voltage resonant waveform corresponding to one of the plurality of direction detecting coils 602, the processing circuit 6032 may be configured to determine at least one point from the voltage resonant waveform, and acquire the second Q value of the direction detecting coil 602 based on the voltage and the sampling instant corresponding to the at least one point. For example, as shown in FIG. 10, the processing circuit 6032 may be configured determine three points from the voltage resonant waveform, and time intervals between the sampling instants corresponding to any two adjacent points of the three points are the same as each other.

As shown in FIG. 11, in some embodiments of the present disclosure, the detecting circuit 603 may include a plurality of Q value measurement circuits 6031. Each of the plurality of Q value measurement circuits 6031 is connected to the processing circuit 6032. Each of the plurality of Q value measurement circuits 6031 is connected to one of each of the plurality of direction detecting coils 602 and the first coil 601 arranged in the first end device. The plurality of Q value measurement circuits 6031 are connected to different coils. In other words, any one of the plurality of direction detecting coils 602 and the first coil 601 arranged in the first end device is connected to a corresponding one of the plurality of Q value measurement circuits 6031.

In a case corresponding to FIG. 11, each of the plurality of Q value measurement circuits 6031 is configured to excite a target coil to generate a resonance, sample voltages at two ends of the target coil after the target coil generates the resonance, and output sampling results to the processing circuit 6032. The target coil is one of the plurality of direction detecting coils 602 or the first coil 601 that is connected to the each of the plurality of Q value measurement circuits 6031.

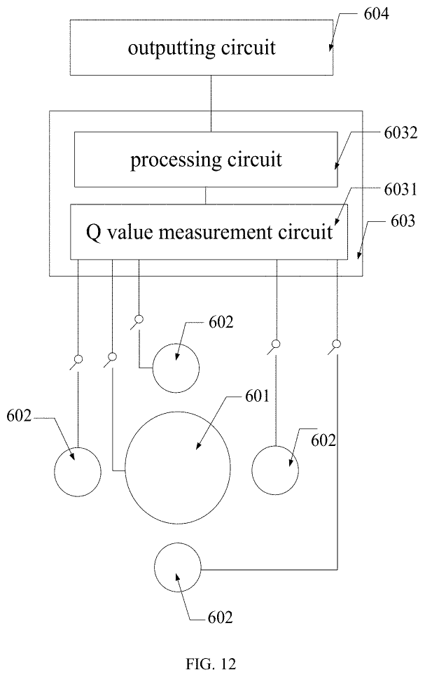

As shown in FIG. 12, in some embodiments of the present disclosure, the detecting circuit 603 may include one Q value measurement circuit 6031. The one Q value measurement circuit 6031 is connected to the first coil 601 and each of the plurality the direction detecting coils 602 in a time-sharing mode. That is, the one Q value measurement circuit 6031 may only be connected to one coil at one moment, and the one coil may be the first coil 601, or one of the plurality of direction detecting coils 602. In some embodiments of the present disclosure, a time-sharing connection between the one Q value measurement circuit 6031 and each of the first coil 601 and the plurality the direction detecting coils 602 may be realized by using a switch. For example, as shown in FIG. 12, a switch is arranged between the one Q value measurement circuit and the one coil selected from the first coil 601 and the plurality of the direction detecting coils 602. Only one switch is allowed to be switched on at one moment, and all other switches are switched off.

In a case corresponding to FIG. 12, the one Q value measurement circuit 6031 is configured to excite a target coil at a current moment to generate a resonance, sample voltages at two ends of the target coil at the current moment after the target coil at the current moment generates the resonance, and output sampling results to the processing circuit 6032.

As shown in FIG. 13, in some embodiments of the present disclosure, each Q value measurement circuit 6031 may include an exciting power supply for an alternating current, a capacitor b, and a voltage sampling circuit c.

The capacitor b is connected to the target coil z. As described aforesaid, the target coil z refers to a coil connected to the Q value measurement circuit 6031. The target coil z may be the first coil 601 or one of the plurality of direction detecting coils 602. It should be noted that, although FIG. 13 shows that the capacitor b and the target coil z are connected in series, in practical applications, the capacitor b and the target coil z may also be connected in parallel.

The exciting power supply for the alternating current is configured to output an alternating current to the capacitor b and the target coil z, and the alternating current is configured to excite the target coil to generate the resonance. For example, the alternating current may be an alternating current of ±3V.

The voltage sampling circuit c is connected to the target coil z to sample the voltages at two ends of the target coil z and output the sampling results to the processing circuit 6032. In some embodiments, the voltage sampling circuit c may be connected in parallel with the target coil z.

In some embodiments of the present disclosure, each Q value measurement circuit 6031 may also include a resistance. The resistance is connected to the capacitor b and the target coil z. In case that the capacitor b and the target coil z are connected in series, the resistance is also connected to the capacitor b and the target coil z in series. In case that the capacitor b and the target coil z are connected in parallel, the resistance is connected in series with a parallel connection of the capacitor b and the target coil z.

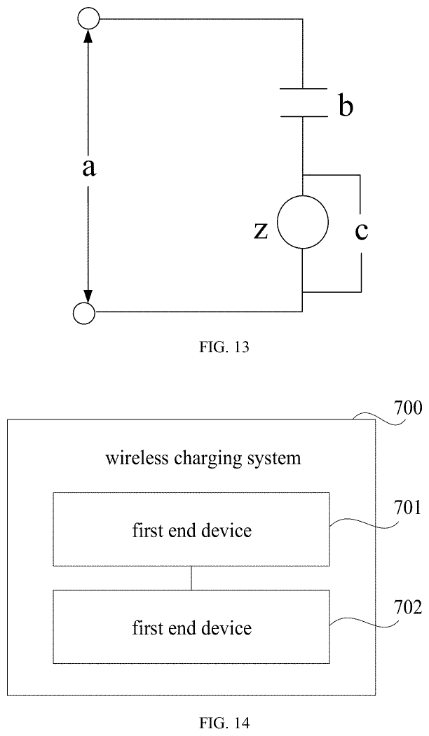

As shown in FIG. 14, the embodiments of the present disclosure further provide a wireless charging system 700. The wireless charging system 700 includes a second end device 702 and the first end device 701 described aforesaid.

In some embodiments of the present disclosure, a non-transitory computer-readable storage medium is provided. A computer program is stored on the non-transitory computer-readable storage medium. In response to being executed by a processor, the computer program executes the following operations: detecting whether there is a position offset between the second coil and the first coil; obtaining a target offset distance between the second coil and the first coil in case that there is the position offset between the second coil and the first coil, and detecting a target offset direction of the second coil relative to the first coil by using the plurality of direction detecting coils in case that there is the position offset between the second coil and the first coil; and outputting position-movement prompting information according to the target offset direction and the target offset distance. Herein, the position-movement prompting information is configured to prompt a user to move the second end device or the first end device based on the target offset distance and the target offset direction.

In some embodiments of the present disclosure, in response to being executed by the processor, the computer program executes the following operations: detecting a first Q value of the first coil; and determining that there is the position offset between the second coil and the first coil in case that the first Q value is in a first preset Q value range. The first preset Q value range is a range of a Q value of the first coil in case that a coil exists in a preset range around the first coil and there is a position offset between the coil that exists around and the first coil.

In some embodiments of the present disclosure, in response to being executed by the processor, the computer program executes the following operations: obtaining the target offset distance according to the first Q value.

In some embodiments of the present disclosure, in response to being executed by the processor, the computer program executes the following operations: detecting a second Q value of each of the plurality of direction detecting coils; and determining the target offset direction according to the second Q value of each of the plurality of direction detecting coils obtained by detecting.

In some embodiment of the present disclosure, in response to being executed by the processor, the computer program executes the following operations: screening one or more target Q values from the second Q value of each of the plurality of direction detecting coils, and determining the target offset direction according to one or more arranging orientations of one or more of the plurality of direction detecting coils corresponding to the one or more target Q values relative to the first coil. Herein, each of the one or more target Q values is in a second preset Q value range. The second preset Q value range is a range of a Q value of each of the plurality of direction detecting coils in case that a coil exists in a preset range around the each of the plurality of direction detecting coils.

In some embodiments of the present disclosure, in response to being executed by the processor, the computer program executes the following operations: determining a first arranging orientation of one of the plurality of direction detecting coils corresponding to the one or more target Q values relative to the first coil in case that the number of the one or more target Q values is 1, and taking the first arranging orientation as the target offset direction; and determining second arranging orientations of at least two of the plurality of direction detecting coils corresponding to the one or more target Q values relative to the first coil in case that the number of the one or more target Q values is greater than 1, and determining the target offset direction according to the second arranging orientations of the at least two of the plurality of direction detecting coils.

In some embodiments of the present disclosure, in response to being executed by the processor, the computer program executes the following operations: taking an orientation between the second arranging orientations of the at least two of the plurality of direction detecting coils as the target offset direction; or determining a target second arranging orientation from the second arranging orientations of the at least two of the plurality of direction detecting coils according to each of the one or more target Q values, and taking the target second arranging orientation as the target offset direction; or calculating the target offset direction based on a preset direction calculation formula by using the second arranging orientations and the one or more target Q values corresponding to the second arranging orientations.

In some embodiments of the present disclosure, in response to being executed by the processor, the computer program executes the following operations: detecting the target offset direction in case that the target offset distance is greater than a preset distance threshold.

The implementation principle and technical effect of the computer-readable storage medium provided by some embodiments are similar to those of the aforesaid method embodiments, which are not be repeated herein.

Any reference to memory, storage, database or other media used in the embodiments provided by the present disclosure may include at least one of non-volatile and volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As an illustration rather than a limitation, the RAM is available in many forms, such as a static RAM (SRAM), a dynamic RAM (DRAM), a synchronous DRAM (SDRAM), a dual data rate SDRAM (DDRSDRAM), an enhanced SDRAM (ESDRAM), a synchronous link DRAM (SLDRAM), a Rambus direct RAM (RDRAM), a direct Rambus dynamic RAM (DRDRAM), and a Rambus dynamic RAM (RDRAM).

The technical features of the above embodiments may be arbitrarily combined. All possible combinations of the technical features of the above embodiments have not been described for a concise description. However, the combination of these technical features should be considered as the scope of the description as long as there is no contradiction.

The above embodiments are only several embodiments of the present disclosure that have relatively specific and detailed description, and should not be understood as a limitation on the scope of the present disclosure. It should be noted that, for those skilled in the art, some modifications and improvements may be obtained without departing from the concept of the present disclosure, these modifications and improvements belong to the protection scope of the present disclosure. Therefore, the protection scope of the present disclosure shall be subject to the appended claims.

What is claimed is:

1. A charging prompt method for a first end device of a wireless charging system, wherein the wireless charging system comprises the first end device and a second end device, the first end device is one of a receiving-end device and a transmitting-end device, the second end device is another of the receiving-end device and the transmitting-end device, the first end device comprises a first coil configured to transfer electric energy, the second end device comprises a second coil configured to transfer the electric energy, and the method comprises:
detecting whether a position offset exists between the second coil and the first coil according to a first Q value of the first coil;
obtaining position-offset information between the second coil and the first coil in response to detecting that the position offset exists between the second coil and the first coil; and
outputting position-movement prompting information according to the position-offset information, and the position-movement prompting information being configured to prompt a user to move the second end device or the first end device based on the position-offset information.

2. The method according to claim 1, wherein detecting whether the position offset exists between the second coil and the first coil comprises:
detecting the first Q value of the first coil; and
determining that the position offset exists between the second coil and the first coil in response to the first Q value being in a first preset Q value range;
wherein the first preset Q value range is a range of a Q value of the first coil in response to a coil existing in a preset range around the first coil and a position offset existing between the coil that exists around and the first coil.

3. The method according to claim 2, wherein the first end device further comprises a plurality of direction detecting coils around the first coil, the position-offset information comprises a target offset distance and a target offset direction, and obtaining position-offset information between the second coil and the first coil comprises:
obtaining a target offset distance between the second coil and the first coil and detecting a target offset direction of the second coil relative to the first coil by using the plurality of direction detecting coils.

4. The method according to claim 3, wherein obtaining the target offset distance between the second coil and the first coil comprises:
obtaining the target offset distance according to the first Q value.

5. The method according to claim 3, wherein detecting the target offset direction of the second coil relative to the first coil by using the plurality of direction detecting coils comprises:
detecting a second Q value of each of the plurality of direction detecting coils; and
determining the target offset direction according to the second Q value of each of the plurality of direction detecting coils obtained by detecting.

6. The method according to claim 5, wherein determining the target offset direction according to the second Q value of each of the plurality of direction detecting coils obtained by detecting comprises:
screening one or more target Q values from the second Q value of each of the plurality of direction detecting coils, each of the one or more target Q values being in a second preset Q value range, and the second preset Q value range being a range of a Q value of each of the plurality of direction detecting coils in response to a coil existing in a preset range around the each of the plurality of direction detecting coils; and
determining the target offset direction according to one or more arranging orientations of one or more of the plurality of direction detecting coils corresponding to the one or more target Q values relative to the first coil.

7. The method according to claim 6, wherein determining the target offset direction according to one or more arranging orientations of one or more of the plurality of direction detecting coils corresponding to the one or more target Q values relative to the first coil comprises:
determining a first arranging orientation of one of the plurality of direction detecting coils corresponding to the one or more target Q values relative to the first coil in response to a number of the one or more target Q values being 1, and taking the first arranging orientation as the target offset direction; and
determining second arranging orientations of at least two of the plurality of direction detecting coils corresponding to the one or more target Q values relative to the first coil in response to the number of the one or more target Q values being greater than 1, and determining the target offset direction according to the second arranging orientations of the at least two of the plurality of direction detecting coils.

8. The method according to claim 7, wherein determining the target offset direction according to the second arranging orientations of the at least two of the plurality of direction detecting coils comprises:
taking an orientation between the second arranging orientations of the at least two of the plurality of direction detecting coils as the target offset direction; or
determining a target second arranging orientation from the second arranging orientations of the at least two of the plurality of direction detecting coils according to the one or more target Q values, and taking the target second arranging orientation as the target offset direction; or
calculating the target offset direction based on a preset direction calculation formula by using the second arranging orientations and the one or more target Q values corresponding to the second arranging orientations.

9. The method according to claim 3, wherein detecting the target offset direction of the second coil relative to the first coil comprises:
detecting the target offset direction in response to the target offset distance being greater than a preset distance threshold.

10. The method according to claim 1, wherein the method is executed before transferring the electric energy.

11. A first end device, comprising:
a first coil configured to transfer electric energy, a plurality of direction detecting coils, a detecting circuit, and an outputting circuit, wherein the plurality of direction detecting coils are arranged around the first coil, the first coil and the plurality of direction detecting coils are connected to the detecting circuit, and the detecting circuit is connected to the outputting circuit;
wherein the detecting circuit is configured to:
detect a first Q value of the first coil and a second Q value of each of the plurality of direction detecting coils;
determine whether a position offset exists between the first coil and a second coil of a second end device according to the first Q value, the second coil being configured to transfer electric energy;
obtain a target offset distance between the second coil and the first coil according to the first Q value and determine a target offset direction of the second coil relative to the first coil according to the second Q value of each of the plurality of direction detecting coils in response to detecting that the position offset exists between the second coil and the first coil; and
wherein the outputting circuit is configured to output position-movement prompting information under a control of the detecting circuit, and the position-movement prompting information is configured to prompt a user to move the second end device or the first end device based on the target offset distance and the target offset direction.

12. The first end device according to claim 11, wherein the detecting circuit comprises one or more Q value measurement circuits and a processing circuit connected to each other, the one or more Q value measurement circuits are connected to the first coil and the plurality of direction detecting coils, and the processing circuit is connected to the outputting circuit;
wherein the one or more Q value measurement circuits are configured to excite the first coil and each of the plurality of direction detecting coils to generate resonances, sample voltages at two ends of the first coil and each of the plurality of direction detecting coils after the first coil and each of the plurality of direction detecting coils generate the resonances, and output sampling results to the processing circuit;
wherein the processing circuit is configured to:
acquire the first Q value and the second Q value of each of the plurality of direction detecting coils according to the sampling results;
determine whether the position offset exists between the second coil and the first coil according to the first Q value;
obtain the target offset distance according to the first Q value and determine the target offset direction according to the second Q value of each of the plurality of direction detecting coils in response to detecting that the position offset exists between the second coil and the first coil; and
control the outputting circuit to output the position-movement prompting information.

13. The first end device according to claim 12, wherein the one or more Q value measurement circuits comprise a plurality of Q value measurement circuits, each of the plurality of Q value measurement circuits is connected to the processing circuit, and each of the plurality of Q value measurement circuits is connected to one of each of the plurality of direction detecting coils and the first coil; and
each of the plurality of Q value measurement circuits is configured to excite a target coil to generate a resonance, sample voltages at two ends of the target coil after the target coil generates the resonance, and output sampling results to the processing circuit, and wherein the target coil is one of the plurality of direction detecting coils or the first coil that is connected to the each of the plurality of Q value measurement circuits.

14. The first end device according to claim 12, wherein the one or more Q value measurement circuits comprise one Q value measurement circuit, the one Q value measurement circuit is connected to the first coil and each of the plurality of direction detecting coils in a time-sharing mode;
wherein the one Q value measurement circuit is configured to excite a target coil at a current moment to generate a resonance, sample voltages at two ends of the target coil at the current moment after the target coil at the current moment generates the resonance, and output sampling results to the processing circuit, and wherein the target coil is one of the plurality of direction detecting coils or the first coil that is connected to the one Q value measurement circuit.

15. The first end device according to claim 13, wherein each of the one or more Q value measurement circuits comprises an exciting power supply for an alternating current, a capacitor, and a voltage sampling circuit;
wherein the capacitor is connected to the target coil, the exciting power supply for the alternating current is configured to output the alternating current to the capacitor and the target coil, and the alternating current is configured to excite the target coil to generate the resonance;
wherein the voltage sampling circuit is connected to the target coil and configured to sample the voltages at two ends of the target coil and output the sampling results to the processing circuit.

16. The first end device according to claim 11, wherein distances between the first coil and the plurality of direction detecting coils are the same as each other.

17. The first end device according to claim 11, wherein the detecting circuit is configured to determine that the position offset exists between the second coil and the first coil in response to the first Q value being in a first preset Q value range; and
wherein the first preset Q value range is a range of a Q value of the first coil in response to a coil existing in a preset range around the first coil and a position offset existing between the coil that exists around and the first coil.

18. The first end device according to claim 11, wherein the detecting circuit is configured to obtain the target offset distance according to the first Q value.

19. The first end device according to claim 11, wherein the detecting circuit is configured to:
screen one or more target Q values from the second Q value of each of the plurality of direction detecting coils, each of the one or more target Q values being in a second preset Q value range, and the second preset Q value range being a range of a Q value of each of the plurality of direction detecting coils in response to a coil existing in a preset range around the each of the plurality of direction detecting coils; and
determine the target offset direction according to one or more arranging orientations of one or more of the plurality of direction detecting coils corresponding to the one or more target Q values relative to the first coil.

20. A non-transitory computer-readable storage medium storing a computer program, wherein in response to the computer program being executed by a processor, a charging prompt method for a first end device of a wireless charging system is executed, wherein the wireless charging system comprises the first end device and a second end device, the first end device is one of a receiving-end device and a transmitting-end device, the second end device is another of the receiving-end device and the transmitting-end device, the first end device comprises a first coil configured to transfer electric energy, the second end device comprises a second coil configured to transfer the electric energy, and the method comprises:
detecting whether a position offset exists between the second coil and the first coil according to a first Q value of the first coil;
obtaining position-offset information between the second coil and the first coil in response to detecting that the position offset exists between the second coil and the first coil; and
outputting position-movement prompting information according to the position-offset information, and the position-movement prompting information being configured to prompt a user to move the second end device or the first end device based on the position-offset information.
